(19) United States
(12) Patent Application Publication
(10) Pub. No.: US 2013/0003035 A1
(43) Pub. Date: Jan. 3, 2013

(54) APPARATUS AND METHOD FOR LITHOGRAPHY

(75) Inventors: Sung Hwan Chang, Daejeon (KR); Tae-Jin Je, Daejeon (KR); Sung-Hak Cho, Daejeon (KR); Kyung-Hyun Whang, Daejeon (KR); Jae Gu Kim, Daejeon (KR); Yeong-Eun Yoo, Daejeon (KR)

(73) Assignee: KOREA INSTITUTE OF MACHINERY & MATERIALS, Daejeon (KR)

(21) Appl. No.: 13/519,273

(22) PCT Filed: Mar. 23, 2011
(86) PCT No.: PCT/KR2011/002004

§ 371 Date: Jun. 26, 2012

(30) Foreign Application Priority Data
Mar. 24, 2010 (KR) 10-2010-0026291

(51) Int. Cl. G03B 27/72

(52) U.S. Cl. 355/71

(57) ABSTRACT

A lithography apparatus is provided. The lithography apparatus includes: a polarizing filter that converts incident light to first polarized light having a single polarizing direction; and a photo mask that is disposed to be separated from the polarizing filter and in which a polarizing pattern having a polarization axis of a predetermined direction in order to convert the applied first polarized light to second polarized light by adjusting a transmittance of the first polarized light and a light blocking pattern that blocks the first polarized light are formed, wherein by radiating light in which a transmittance is adjusted in the photo mask, the photoresist is patterned. Thereby, a lithography apparatus that can embody patterning having repeatability is

### CROSS-REFERENCE TO RELATED APPLICATION

This application claims priority to and the benefit of Korean Patent Application No. 10-2010-0026291 filed in the Korean Intellectual Property Office on Mar. 24, 2010, the entire contents of which are incorporated herein by reference.

### BACKGROUND OF THE INVENTION

(a) Field of the Invention

The present invention relates to a method and apparatus for lithography. More particularly, the present invention relates to a method and apparatus for lithography that can embody patterning with constant repeatability by quantitatively controlling an exposure amount.

(b) Description of the Related Art

In order to produce a faster and more complicated circuit, a semiconductor industry continues an effort that minimizes a size of a circuit element. Lithography is one of methods of realizing such an effort.

Lithography is a kind of a printing method of forming a predetermined pattern by chemically changing a photoresist by radiating light through a mask that is patterned in a predetermined shape and by radiating light that transmits the mask to photoresists, which are radiation sensible materials that are stacked on a substrate, and by removing an exposed area through thermal and chemical processing.

FIG. 1 is a perspective view illustrating an example of a lithography apparatus using a conventional gray scale mask.

Referring to FIG. 1, a lithography apparatus 10 using a conventional gray scale mask applies light to a gray scale mask 11 in which a slit 12 having a predetermined width n1 and gap n2 is formed and patterns a photoresist 13 by radiating light that is diffracted by passing through the slit 12 to the photoresist 13.

However, according to such a conventional lithography apparatus, light radiation was somewhat controlled by the width n1 and the gap n2 of the slit 12, but it was difficult to accurately estimate an overlapped effect of diffracted light and thus it was difficult to quantitatively control light. Therefore, the width n1 and the gap n2 of the slit 12 were determined and a light quantity condition was controlled depending on an experiential result that is acquired through a plurality of experimental attempts.

Further, it was difficult to have constant repeatability in a size, a form, and a thickness of patterns that are embodied by a conventional lithography apparatus due to irregular light radiation.

Further, in conventional lithography, repeated patterning of a simple form can be easily performed on a substrate of a large area, but in order to embody three-dimensional shape patterning having a complex bent, a limitation exists in using conventional lithography.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a lithography apparatus having advantages of quantitatively controlling a light quantity that is radiated to a photoresist by using a polarized light phenomenon.

The present invention has been made in an effort to further provide a lithography method having advantages of embodying patterning of a complex three-dimensional shape on a substrate using a two-dimensional photo mask.

An exemplary embodiment of the present invention provides a lithography apparatus including: a polarizing filter that converts incident light to first polarized light having a single polarizing direction; and a photo mask that is disposed to be separated from the polarizing filter and in which a polarizing pattern having a polarization axis of a predetermined direction in order to convert the applied first polarized light to second polarized light by adjusting a transmittance of the first polarized light and a light blocking pattern that blocks the first polarized light are formed, wherein by radiating light in which a transmittance is adjusted in the photo mask, the photoresist is patterned.

The polarizing pattern may be formed with a plurality of stripe lattices that make a direction of the polarization axis in a length direction, but the plurality of stripe lattices may be separated with a predetermined pitch.

The photo mask may include a plurality of polarizing patterns having polarization axes of different directions.

The any one polarizing pattern may be formed adjacent to a neighboring polarizing pattern.

The lithography apparatus may further include a diffuser that smoothly converts an interface that is generated by different light distribution that is included in the second polarized light.

Another embodiment of the present invention provides a lithography method including: converting incident light to first polarized light by passing through a polarizing filter; passing through, by the first polarized light, a photo mask in which a polarizing pattern having a polarization axis of a predetermined direction is formed; converting the first polarized light to second polarized light in which a transmitting amount is adjusted by passing through the photo mask and radiating the second polarized light to a photoresist; and patterning the photoresist by the radiated second polarized light.

The passing through of a photo mask may include forming, by the second polarized light that passes through the photo mask, a plurality of areas having different transmitting amounts.

According to the present invention, a lithography apparatus that can minimize a production error by controlling radiated light to a predetermined amount is provided.

Further, by providing a plurality of polarizing patterns having different polarization axes, a photoresist can be patterned in a shape of a complex form having different thicknesses.

Further, by adjacently forming a neighboring polarizing pattern, a photoresist can be adjacently patterned in a shape having different thicknesses.

Further, a lithography method of patterning in a three-dimensional shape using a two-dimensional photo mask is provided.

### BRIEF DESCRIPTION OF THE DRAWINGS

FIG. 1 is a perspective view illustrating an example of a conventional lithography apparatus.

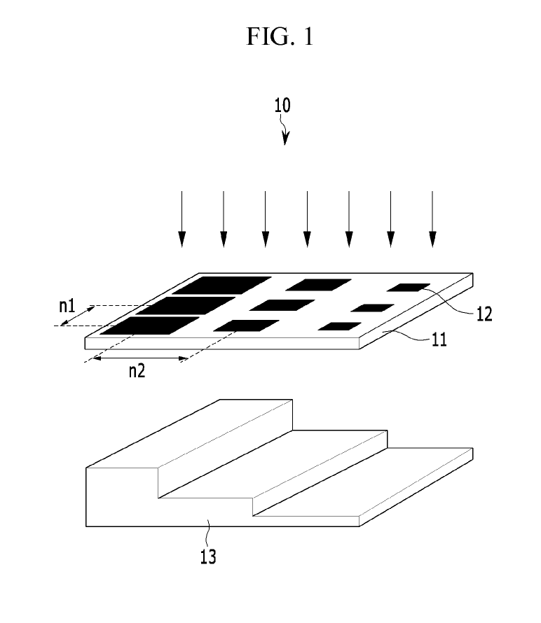

FIG. 2 is a diagram illustrating a lithography apparatus according to an exemplary embodiment of the present invention.

FIG. 3 is a diagram illustrating a photo mask of the lithography apparatus of FIG. 2.

FIG. 4 is a diagram illustrating a principle that converts first polarized light of the lithography apparatus of FIG. 2 to second polarized light.

FIG. 5 is a diagram illustrating an operation process in which a lithography apparatus excluding a diffuser of FIG. 2 patterns a photoresist.

FIG. 6 is a diagram illustrating an operation process in which a lithography apparatus including a diffuser of FIG. 2 patterns a photoresist.

FIG. 7 is a flowchart illustrating a process of a lithography method according to an exemplary embodiment of the present invention.

<Description of Reference Numerals Indicating Primary
Elements in the Drawings>

| | |
|---|---|
| 100: lithography apparatus | 130: photo mask |
| 110: light source | 140: diffuser |
| 120: polarizing filter | |

### DETAILED DESCRIPTION OF THE EMBODIMENTS

Hereinafter, a lithography apparatus according to an exemplary embodiment of the present invention will be described in detail with reference to the drawings.

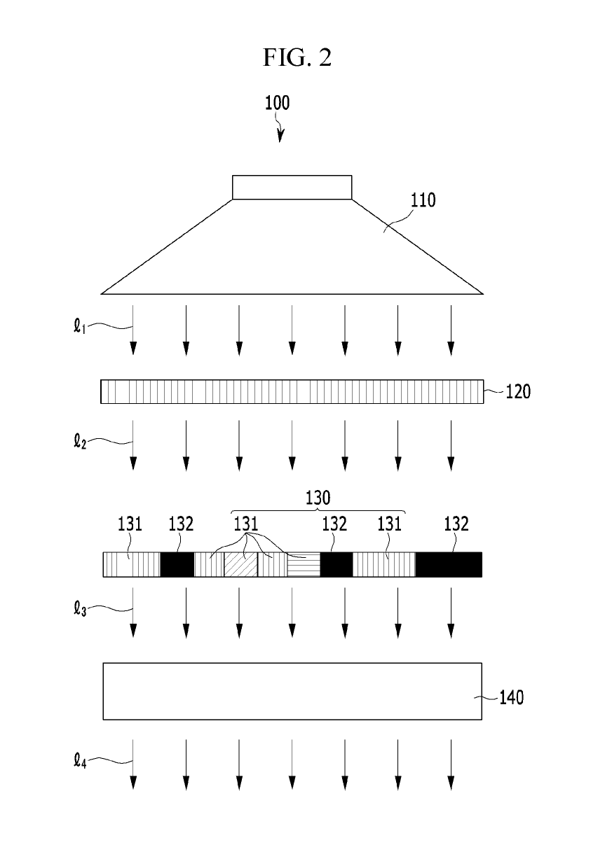

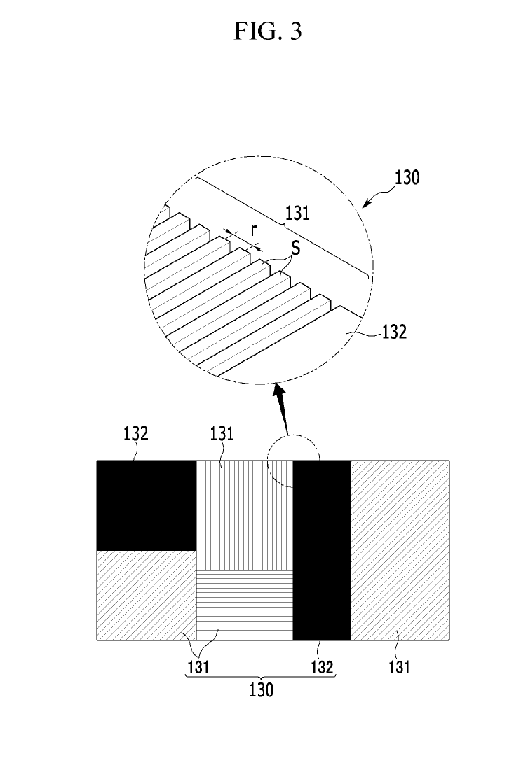

FIG. 2 is a diagram illustrating a lithography apparatus according to an exemplary embodiment of the present invention, and FIG. 3 is a diagram illustrating a photo mask of the lithography apparatus of FIG. 2.

Referring to FIGS. 2 and 3, a lithography apparatus 100 according to an exemplary embodiment of the present invention includes a light source 110, a polarizing filter 120, a photo mask 130, and a diffuser 140.

The light source 110 is a device that radiates UV light. However, the light source 110 is not limited thereto and may be a lineal polarizing device such as a laser radiation device.

The polarizing filter 120 converts incident light l1 that receives from the light source 110 to first polarized light l2, which is polarized light having a polarization axis of a single direction and is separated by a predetermined gap from the light source 110.

The photo mask 130 converts the first polarized light l2 to second polarized light l3 and includes a polarizing pattern 131 and a light blocking pattern 132.

The polarizing pattern 131 emits the applied first polarized light l2 downward by adjusting a transmittance of the first polarized light l2 and is provided in plural. The plurality of polarizing patterns 131 are combined and have the same cross-section as that of a photoresist shape to form through light radiation.

Therefore, the plurality of polarizing patterns 131 may be adjacently disposed according to a shape of a photoresist pattern to form, and the light blocking pattern 132 may be disposed between the polarizing patterns 131, and the polarizing patterns 131 may be separately disposed.

Each polarizing pattern 131 is formed in a structure in which a plurality of stripe-shaped lattices s are combined. A plurality of stripe-shaped lattices s that are provided within a random polarizing pattern 131 are separately disposed by a predetermined gap, and the separated gap is defined as a pitch r.

In the present exemplary embodiment, a pitch r is determined in a range of 30 nm to 600 nm, but the pitch r is not limited thereto, and it is preferable that the pitch r is manufactured to induce a polarized light phenomenon in consideration of a size of a photo mask, a production cost, and a method of forming a stripe-shaped lattice.

A polarized light axis, which is a virtual axis that is extended in a length direction of the stripe-shaped lattice s is formed in the random polarizing pattern 131.

In this case, as a polarization axis of each polarizing pattern 131 receives application of Malus' law to be described later, when converting the applied first polarized light l2 to the second polarized light l3, the polarization axis operates as a factor of determining a light transmission amount and thus it is preferable that the polarization axis is determined in consideration of a thickness of a photoresist pattern to form after exposure.

The polarization pattern 131 in which a stripe-shaped lattice s is formed may be manufactured by a method such as nano imprint and electron-beam lithography, but may be manufactured with a method that can perform nano patterning.

The light blocking pattern 132 prevents the first polarized light l2 from passing through and suppresses light from being radiated downward of a position at which the light blocking pattern 132 is formed.

Therefore, the first polarized light l2 that is applied to the photo mask 130 that are formed with a combination of such a plurality of polarizing patterns 131 and light blocking patterns 132 is converted to the second polarized light l3 constituting a cross-section of an entirely predetermined shape with a combination of an area having different transmitting light quantities.

The diffuser 140 is separately installed from the photo mask 130 at a lower side of the photo mask 130. When the second polarized light l3 passes through the diffuser 140, a discontinuous interface within the second polarized light l3 that is formed by an area including a different light quantity is smoothly formed to be adjusted similarly to a continuous surface.

Hereinafter, operation of a first exemplary embodiment of the lithography apparatus will be described.

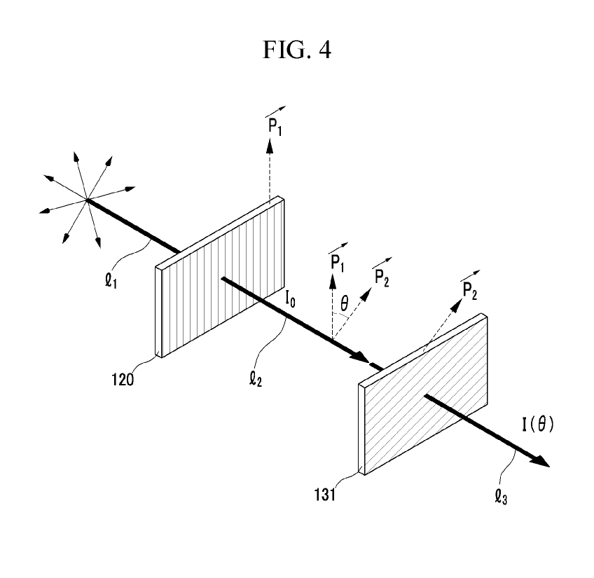

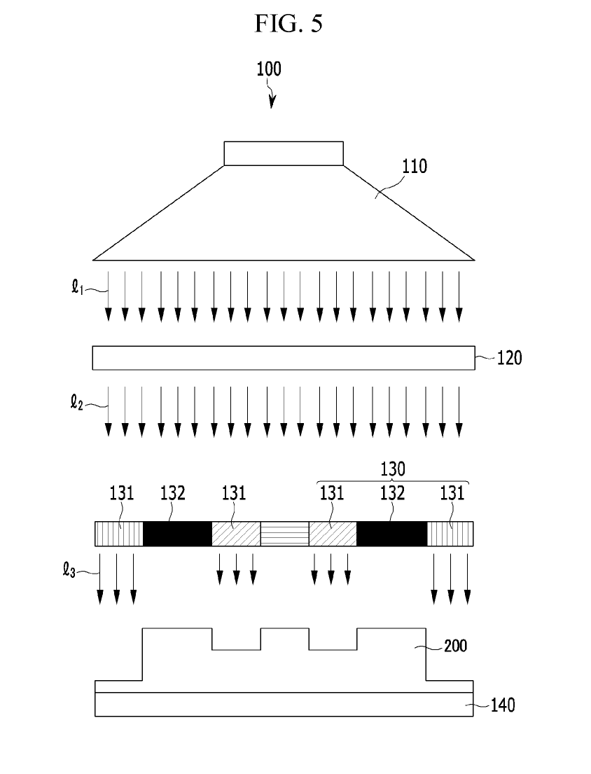

FIG. 4 is a diagram illustrating a principle that converts first polarized light of the lithography apparatus of FIG. 2 to second polarized light, and FIG. 5 is a diagram illustrating an operation process in which a lithography apparatus excluding a diffuser of FIG. 2 patterns a photoresist.

Hereinafter, a photoresist 200 that is used in the present exemplary embodiment is a positive type that is patterned in a form that is removed by radiated light.

Referring to FIGS. 4 and 5, when incident light l1 that is generated in a light source is applied to a polarizing filter, entire polarized light of polarization axes, except for a single polarization axis is filtered and thus polarized light of the incident light l1 is converted to the first polarized light l2, which is shortened polarized light, and the incident light l1 is thus emitted to an uniform light quantity.

The first polarized light l2 that is emitted from the polarizing filter 120 is applied to the photo mask 130. The first polarized light l2 that is applied to a light blocking portion 132 that is formed on the photo mask 130 is completely blocked instead of being radiated downward.

However, the first polarized light l2 that is applied to the polarizing pattern 131 is converted to the second polarized light l3 in which a light quantity is adjusted to be radiated to the photoresist 200 on a substrate 300.

Referring to FIG. 4, when a light quantity of the first polarized light l2 that is applied to the polarizing pattern 131 is referred to as I0 and an angle that is formed by a unit vector of an optical axis that is formed in the polarizing filter 120 and a unit vector P̅₂ of a polarization axis that is formed in the random polarizing pattern 131 is θ, intensity I(θ) of the second polarized light l3 is quantitatively determined by Equation 1, which is Malus' law.

I(θ)=Iₒ×cos²(θ) [Equation 1]

Therefore, in the lithography apparatus 100 according to the present exemplary embodiment, as θ decreases, a light quantity of the second polarized light l3 that is radiated by transmitting downward increases, and as θ increases, a light quantity of the second polarized light l3 decreases, and when θ becomes 90°, the polarizing pattern 131 does not transmit light and thus performs the same operation as that of the light blocking pattern 132.

In the above-described method, by radiating the second polarized light l3 including an area in which a light quantity is differently adjusted to the photoresist 200, the photoresist 200 causes a change in a chemical structure, and by removing the photoresist 200 of an area in which light is radiated through a process in which light reacts with a chemical material, the photoresist 200 can be patterned in a desired form.

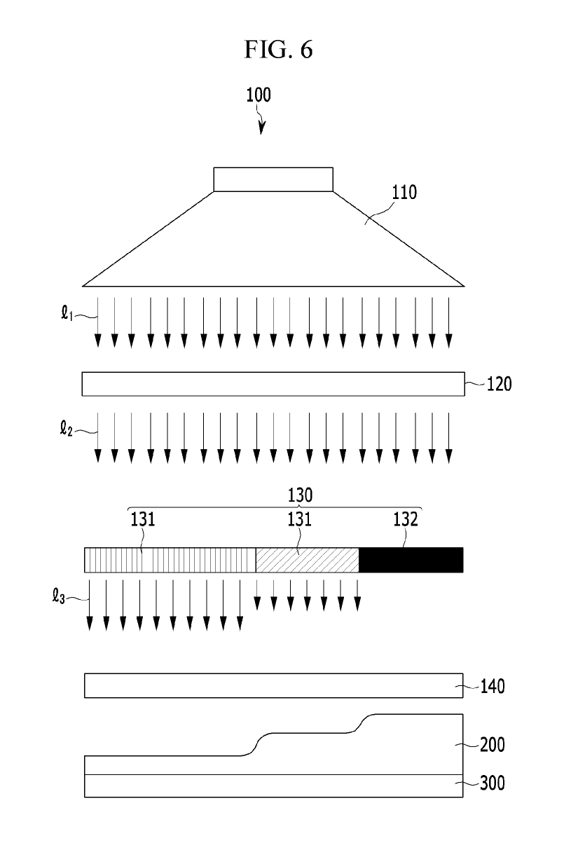

FIG. 6 is a diagram illustrating an operation process in which a lithography apparatus including a diffuser of FIG. 2 patterns a photoresist.

Referring to FIG. 6, the diffuser 140 is disposed at a lower side of the photo mask 130, by enabling some area or an entire area of the second polarized light l3 to pass through the diffuser 140 and enabling the passed second polarized light l3 to radiate to the photoresist 200 on the substrate 300, a discontinuous interface that is included in the second polarized light l3 that is formed by a difference of a light quantity is smoothly formed and thus the photoresist 200 may be patterned to form an interface in a continuous curved line.

In the present exemplary embodiment, a positive type photoresist is a target, but in an exemplary variation of the present exemplary embodiment, by using a negative type photoresist in which an area in which light is not radiated is removed, in a portion in which a shape of a larger thickness is necessary, unlike a case of using a positive type photoresist, a method of curing a photoresist is used by adjusting a polarization axis of a polarizing pattern in order to increase a light quantity of the second polarized light.

Therefore, according to a conventional lithography apparatus, it was difficult to control an exposure amount, but when using a lithography apparatus according to the present exemplary embodiment, by controlling an exposure amount, a thickness of a photoresist shape can be quantitatively adjusted with constant repeatability.

Further, conventionally, when disposing a polarizing plate at a lower surface of a photo mask, a shape having a thickness difference cannot be adjacently formed on the photoresist, but according to a lithography apparatus of the present exemplary embodiment, a polarizing pattern may be formed adjacent to a neighboring polarizing pattern, and the polarizing patterns may have different polarization axes and thus a shape that is adjacently formed on the photoresist can be induced to have different thicknesses.

Hereinafter, a lithography method according to an exemplary embodiment of the present invention will be described.

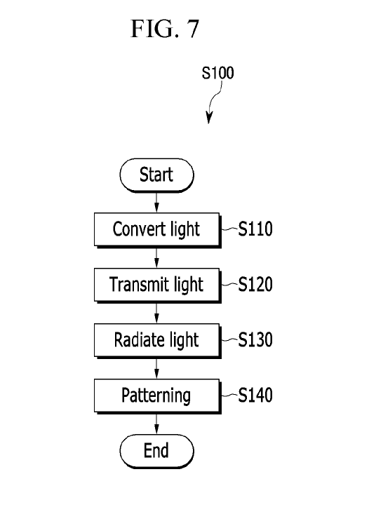

FIG. 7 is a flowchart illustrating a process of a lithography method according to an exemplary embodiment of the present invention.

Referring to FIG. 7, a lithography method (S100) according to an exemplary embodiment of the present invention includes step of converting light (S110), step of transmitting light (S120), step of radiating light (S130), and step of patterning (S140).

The step of converting light (S110) is step of converting incident light that is generated in a light source to first polarized light having a single axis by transmitting the incident light to a polarizing film having a polarization axis of a single axis direction.

The step of transmitting light (S120) is step of converting the first polarized light to the second polarized light by enabling the first polarized light to pass through a photo mask. A combination of a plurality of polarizing patterns for adjusting a transmittance of the applied first polarized light and a plurality of light blocking patterns that block transmission of the first polarized light is formed on the photo mask.

A random polarizing pattern has a structure in which a plurality of stripe-shaped lattices are separated by a predetermined gap and are repeatedly disposed, and a polarization axis, which a virtual axis that is extended in a length direction of the stripe-shaped lattice is formed in the polarizing pattern.

The first polarized light that passes through a photo mask is converted to the second polarized light and is radiated to a photoresist at step of radiating light (S130) to be described later and thus the photo mask is formed with a combination of a polarizing pattern and a light blocking pattern so that a cross-section of the second polarized light corresponds to a cross-section of a shape of a photoresist to form.

Further, an angle θ that is formed by a polarization axis of a polarizing film and a polarization axis of a polarizing pattern receives application of Malus' law and thus a light quantity of the second polarized light is adjusted.

Step of radiating light (S130) is step of radiating the converted second polarized light on a photoresist. When the photoresist is exposed in a predetermined shape by the second polarized light, a chemical change occurs in an exposed area of the photoresist.

Step of patterning (S140) is step of removing some area by performing a heat treatment or a chemical treatment to the photoresist. At step of radiating light (S130), when performing a heat treatment or a chemical treatment of the exposed photoresist, the photoresist is removed with a differential method according to an exposure degree and is patterned in a desired shape.

An amount of the removed photoresist is proportional to a light quantity of the radiated second polarized light, and a light quantity of the second pattern is determined by a polarization axis that is formed in the polarizing pattern. Therefore, the photoresist is remained in different thicknesses in each area due to a difference of a removed amount and is entirely patterned in a shape having a predetermined bent.

Therefore, when using a conventional lithography method, only patterning having a simple shape can be performed, but when using a lithography method (S100) of the present exemplary embodiment, by quantitatively controlling exposure using a polarizing pattern that is formed in a two-dimensional photo mask, three-dimensional shape patterning having a complex bent can be performed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A lithography apparatus comprising:
a polarizing filter that converts incident light to first polarized light having a single polarizing direction; and
a photo mask that is disposed to be separated from the polarizing filter and in which a polarizing pattern having a polarization axis of a predetermined direction in order to convert the applied first polarized light to second polarized light by adjusting a transmittance of the first polarized light and a light blocking pattern that blocks the first polarized light are formed,
wherein by radiating light in which a transmittance is adjusted in the photo mask, the photoresist is patterned.

2. The lithography apparatus of claim 1, wherein the polarizing pattern is formed with a plurality of stripe lattices that make a direction of the polarization axis in a length direction, but the plurality of stripe lattices are separated with a predetermined pitch.

3. The lithography apparatus of claim 1, wherein the photo mask comprises a plurality of polarizing patterns having polarization axes of different directions.

4. The lithography apparatus of claim 3, wherein the any one polarizing pattern is formed adjacent to a neighboring polarizing pattern.

5. The lithography apparatus of claim 3, further comprising a diffuser that smoothly converts an interface that is generated by different light distribution that is included in the second polarized light.

6. A lithography method comprising:
converting incident light to first polarized light by passing through a polarizing filter;
passing through, by the first polarized light, a photo mask in which a polarizing pattern having a polarization axis of a predetermined direction is formed;
converting the first polarized light to second polarized light in which a transmitting amount is adjusted by passing through the photo mask and radiating the second polarized light to a photoresist; and
patterning the photoresist by the radiated second polarized light.

7. The method of claim 6, wherein the passing through of a photo mask comprises forming, by the second polarized light that passes through the photo mask, a plurality of areas having different transmitting amounts.

8. The lithography apparatus of claim 2, wherein the photo mask comprises a plurality of polarizing patterns having polarization axes of different directions.

9. The lithography apparatus of claim 8, wherein the any one polarizing pattern is formed adjacent to a neighboring polarizing pattern.

10. The lithography apparatus of claim 8, further comprising a diffuser that smoothly converts an interface that is generated by different light distribution that is included in the second polarized light.
